(19) United States
(12) Patent Application Publication
(10) Pub. No.: US 2025/0123891 A1
(43) Pub. Date: Apr. 17, 2025

(54) RESOURCE PROCESSING METHOD AND RESOURCE SCHEDULING METHOD

(71) Applicant: Hangzhou AliCloud Feitian Information Technology Co., Ltd., Hangzhou City (CN)

(72) Inventors: Yu ZHUANG, Beijing (CN); Shuangkun TIAN, Beijing (CN); Qingcan WANG, Beijing (CN); Peng LI, Beijing (CN); Kai ZHANG, Beijing (CN)

(21) Appl. No.: 18/685,448

(22) PCT Filed: Feb. 13, 2023
(86) PCT No.: PCT/CN2023/075632

§ 371 Date: Feb. 21, 2024

(30) Foreign Application Priority Data
Feb. 24, 2022 (CN) 202210173640.7

(51) Int. Cl. G06F 9/50; G06F 9/455; G06F 9/48

(52) U.S. Cl. CPC G06F 9/5027; G06F 9/45558; G06F 9/4881; G06F 2009/45562; G06F 2209/5014

(57) ABSTRACT

The embodiments of the present disclosure provide a resource processing method, a resource scheduling method, a computing device and a computer storage medium, where the resource processing method includes: creating, according to the number of a pod needed by a target application, at least one instance corresponding to the number of the pod for the target application; performing, according to a resource requirement parameter of the at least one instance and respective available resources of multiple nodes respectively, simulation scheduling in the multiple nodes to determine at least one target node and a respective reserved resource thereof; and generating, according to a simulation scheduling result, a resource reservation result of the target application, where the resource reservation result is used to instruct to perform resource scheduling for the target application by using the a reserved resource of the at least one target node.

### CROSS-REFERENCE TO RELATED APPLICATIONS

This application is a National Stage of International Application No. PCT/CN2023/075632, filed on Feb. 13, 2023, which claims priority to Chinese Patent Application No. 202210173640.7, filed to China National Intellectual Property Administration on Feb. 24, 2022 and entitled “RESOURCE PROCESSING METHOD AND RESOURCE SCHEDULING METHOD”, both of which are hereby incorporated by reference in their entireties.

### TECHNICAL FIELD

Embodiments of the present disclosure relates to the technical field of cloud computing and, in particular, to a resource processing method and a resource scheduling method.

### BACKGROUND

Kubernetes is a kind of cloud native technology, which is used to automatically deploy, expand and manage containers. Kubernetes includes multiple nodes, the node is the smallest computing hardware unit in Kubernetes, and each node can provide, for an application program, resources such as computing resources, memory resources that are needed for running of the application program. In Kubernetes, one or more containers are encapsulated in a pod and run on a node.

When creating an application program, the resources needed for running of the application program usually need Kubernetes to perform resource scheduling for the application program. When Kubernetes performs resource scheduling, the pod is usually the smallest scheduling unit, that is, a node that provides the resource needed by the pod is selected from the Kubernetes system, and then the pod is deployed to the node, so that the pod uses the resources provided by the node to provide support for the running of the application program.

However, when users actually use Kubernetes, they will first create an application program, in which parameters such as the number of pods needed and the resource demand of pods are defined. Then multiple pods are created according to the parameters such as the number of pods needed by the application program and resource usage of the pods. When performing resource scheduling by using the default scheduling method of Kubernetes, the multiple pods created by the application program are deployed to nodes respectively. However, if there is a node that cannot meet resource usage of a pod, the scheduling of the pod may fail, resulting in the failure of resource scheduling for the application.

Therefore, how to improve the success rate of resource scheduling becomes a technical problem that needs to be solved urgently.

### SUMMARY

Embodiments of the present disclosure provide a resource processing method, a resource scheduling method, a computing device and a computer storage medium.

In a first aspect, a resource processing method is provided in an embodiment of the present disclosure, including:
creating, according to the number of pod needed by a target application, at least one instance corresponding to the number of the pod for the target application;
performing, according to a resource requirement parameter of the at least one instance and respective available resources of multiple nodes respectively, simulation scheduling in the multiple nodes to determine at least one target node and a respective reserved resource thereof; and
generating, according to a simulation scheduling result, a resource reservation result of the target application, where the resource reservation result is used to instruct to perform resource scheduling for the target application by using the reserved resource of the at least one target node.

In a second aspect, a resource scheduling method is provided in an embodiment of the present disclosure, including:
obtaining a request for requesting to perform resource scheduling for a target application;
obtaining, in response to the request, a pre-generated resource reservation result, where the resource reservation result is generated according to a simulation scheduling result, and the simulation scheduling result includes at least one target node and a reserved resource determined by performing simulation scheduling in multiple nodes according to a resource requirement parameter of at least one instance of the target application and respective available resources of the multiple nodes; and
performing resource scheduling for the target application by using the reserved resource of the at least one target node indicated by the resource reservation result, in a case of determining the resource reservation result indicates that a resources has been reserved for the target application.

In a third aspect, a resource processing apparatus is provided in an embodiment of the present disclosure, including:
an instance creating module, configured to create, according to the number of a pod needed by a target application, at least one instance corresponding to the number of the pod for the target application;
a simulation scheduling module, configured to perform, according to a resource requirement parameter of the at least one instance and respective available resources of multiple nodes respectively, simulation scheduling in the multiple nodes to determine at least one target node and a respective reserved resource thereof;
a result generating module, configured to generate, according to a simulation scheduling result, a resource reservation result of the target application, where the resource reservation result is used to instruct to perform resource scheduling for the target application by using the reserved resource of the at least one target node.

In a fourth aspect, a resource scheduling apparatus is provided in an embodiment of the present disclosure, including:
a request obtaining module, used to obtain a request for requesting to perform resource scheduling for a target application;
a result obtaining module, used to obtain, in response to the request, a pre-generated resource reservation result, where the resource reservation result is generated according to a simulation scheduling result, and the simulation scheduling result includes at least one target node and a reserved resource determined by performing simulation scheduling in multiple nodes according to a resource requirement parameter of the at least one instance of the target application and respective available resources of the multiple nodes; and
a resource scheduling module, configured to perform resource scheduling for the target application by using the reserved resource of the at least one target node indicated by the resource reservation result, in a case of determining the resource reservation result indicates that a resource has been reserved for the target application.

In a fifth aspect, a computing device is provided in an embodiment of the present disclosure, including a processing component and a storage component;
where the storage component stores one or more computer instructions; and the one or more computer instructions are used for being called and executed by the processing component; and
the processing component is configured to:
create, according to the number of a pod needed by a target application, at least one instance corresponding to the number of the pod for the target application;
perform, according to a resource requirement parameter of the at least one instance and respective available resources of multiple nodes respectively, simulation scheduling in the multiple nodes to determine at least one target node and a respective reserved resource thereof; and
generate, according to a simulation scheduling result, a resource reservation result of the target application, where the resource reservation result is used to instruct to perform resource scheduling for the target application by using the reserved resource of the at least one target node.

In a sixth aspect, a computing device is provided in an embodiment of the present disclosure, including a processing component and a storage component;
where the storage component stores one or more computer instructions; and the one or more computer instructions are used for being called and executed by the processing component; and
the processing component is configured to:
obtain a request for requesting to perform resource scheduling for a target application;
obtain, in response to the request, a pre-generated resource reservation result, where the resource reservation result is generated according to a simulation scheduling result, and the simulation scheduling result includes at least one target node and a reserved resource determined by performing simulation scheduling in multiple nodes according to a resource requirement parameter of the at least one instance of the target application and respective available resources of the multiple nodes; and
perform resource scheduling for the target application by using the reserved resource of the at least one target node indicated by the resource reservation result, in a case of determining the resource reservation result indicates that a resource has been reserved for the target application.

In a seventh aspect, a computer storage medium storing a computer program is provided in an embodiment of the present disclosure, where when the computer program is executed by a computer, the resource processing method provided in the embodiment of the present disclosure or the resource scheduling method provided in the embodiment of the present disclosure is implemented.

In the embodiments of the present disclosure, before performing resource scheduling for an application program, according to the number of a pod needed by a target application, at least one instance corresponding to the number of the pod is first created for the target application; according to a resource requirement parameter of the at least one instance and respective available resources of multiple nodes respectively, simulation scheduling in the multiple nodes is performed to determine at least one target node and a respective reserved resource thereof; according to a simulation scheduling result, a resource reservation result of the target application is generated to reserve a resource for the target application, so when performing resource scheduling for the application program, the reserved resource can be directly used for performing the resource scheduling, and the technical effect of improving the success rate of resource scheduling is achieved.

These or other aspects of the present disclosure will be more concise and easy to understand in the description of the following embodiments.

### BRIEF DESCRIPTION OF DRAWINGS

In order to more clearly illustrate the technical solutions of the embodiments of the present disclosure or the prior art, the drawings needed to be used in the description of the embodiments or the prior art will be briefly introduced below. Obviously, the drawings in the following description are some embodiments of the present disclosure, and for those skilled in the art, other drawings may be obtained according to these drawings without paying creative efforts.

FIG. 1 shows a general architecture diagram of a container orchestration tool Kubernetes.

FIG. 2 is a flowchart of an embodiment of a resource processing method according to an embodiment of the present disclosure.

FIG. 3 schematically shows a schematic diagram of a resource processing method according to an embodiment of the present disclosure.

FIG. 4 is a flowchart of an embodiment of a resource scheduling method according to an embodiment of the present disclosure.

FIG. 5 schematically shows a schematic diagram of a resource scheduling method according to an embodiment of the present disclosure.

FIG. 6 is a schematic structural diagram of an embodiment of a resource processing apparatus according to an embodiment of the present disclosure.

FIG. 7 is a schematic structural diagram of an embodiment of a resource scheduling apparatus according to an embodiment of the present disclosure.

FIG. 8 is a schematic structural diagram of an embodiment of a computing device according to an embodiment of the present disclosure.

### DESCRIPTION OF EMBODIMENTS

In order to make those skilled in the art better understand the solutions of the present disclosure, the solutions in the embodiments of the present disclosure will be described clearly and completely in combination with the drawings of the embodiments of the present disclosure.

In some processes described in the description, claims and the above-mentioned drawings of the present disclosure, multiple operations that appear in a specific order are contained, but it should be clearly understood that these operations may be performed out of the order in which they appear here or in parallel. The serial numbers of the operations, such as 101, 102, are only used to distinguish different operations, and the serial numbers themselves do not represent any execution order. In addition, these processes may include more or less operations, and these operations may be performed in order or in parallel. It should be noted that the descriptions such as “first”, “second” herein are used to distinguish different messages, devices, modules, etc., and do not represent the sequence, nor do they limit that “first” and “second” are different types.

The technical solutions provided in the embodiments of the present disclosure may be applied to a container management system, such as Kubernetes, for performing simulation resource scheduling for an application program, so as to achieve the technical effect of improving the success rate of resource scheduling for the application program. In the following one or more embodiments, Kubernetes is mainly used to introduce the technical solutions of the present disclosure.

In the embodiments of the present disclosure, in order to improve the success rate of resource scheduling for an application program, before performing resource scheduling for the application program, according to the number of a pod needed by a target application, at least one instance corresponding to the number of the pod is first created for the target application; according to a resource requirement parameter of the at least one instance and respective available resources of multiple nodes respectively, simulation scheduling in the multiple nodes is performed to determine at least one target node and a respective reserved resource thereof; according to a simulation scheduling result, a resource reservation result of the target application is generated to reserve a resource for the target application, so when performing resource scheduling for the application program, the reserved resource can be directly used for performing resource scheduling, and the technical effect of improving the success rate of resource scheduling is achieved.

In the embodiments of the present disclosure, an application program may include a set of computer programs written for a certain application purpose of a user. After the application program is developed, the application may be deployed to a production environment for the user to use. The production environment refers to an environment where a client actually uses the application program, and the process of deploying the application program to the production environment may also be called the process of bringing the application program online. After the application is deployed to the production environment, it can formally provide services to the outside world.

When the application program is deployed to a physical machine or a virtual machine, some updates to the operating system may damage the application program. For example, one update to the operating system leads to the update of several dependencies to the application program, and some incompatible updates may even cause the application program to run abnormally. In addition, if two or more application programs share a same operating system and some of the same library files (library, lib), the update of the library files of one or some application programs may affect other applications.

Based on this, the application program may also be deployed into a container. A container contains a complete runtime environment. The runtime environment refers to all the dependencies, class libraries, other binary files, configuration files, etc. required by this application except the application program itself. These files are packaged into a package called a container image, so as to form a container.

Since the container packages relevant files necessary for running the application, such as dependencies and the operating system, the application deployed in the container will not be affected by the change of the operating system or the change of dependencies, which ensures that the application can run without interruption. Moreover, it is more flexible to transplant a containerized application from one environment to another environment because there is no need to consider the differences of operating systems.

In some implementations, the application program may be deployed into a pod formed by one or more containers. A pod is a set of containers (including at least one container), and the containers in the pod can share a network and/or a storage. Considering that container applications in the pod are symbiotic, that is, they are started at the same time and terminated at the same time, therefore, multiple containers in one pod usually deploy the same application. When the application includes multiple different application programs, pods may be created for the multiple applications respectively, and each pod is used to deploy one of the multiple application programs.

When the number of containers reaches a certain scale, a container orchestration tool (such as a container orchestration engine) may usually be used to orchestrate the containers, so as to realize automatic deployment, large-scale scalability and application containerization management. The so-called container orchestration refers to the arrangement of an interaction mode between multiple containers deploying the application, so that the containers interact based on a set interaction mode to ensure the normal running of the application.

The container orchestration tool includes many kinds, such as docker swarm, docker compose, Kubernetes or apache meso. For the convenience of description, illustration is made below by taking the container orchestration tool being Kubernetes. The resource processing method provided in an embodiment of the present disclosure includes but is not limited to being applied to Kubernetes.

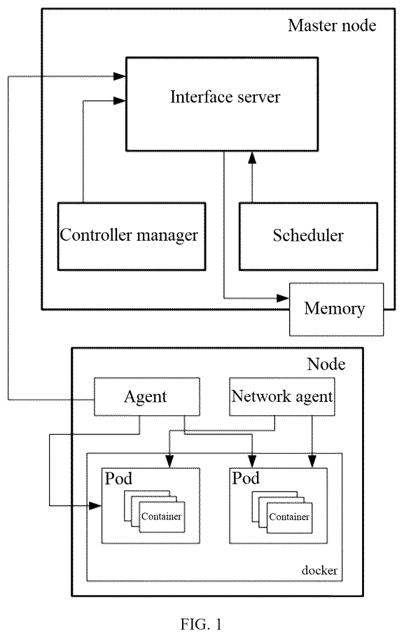

FIG. 1 shows a general architecture diagram of a container orchestration tool Kubernetes.

As shown in FIG. 1, Kubernetes divides the nodes in a cluster into one master node (Master) and at least one working node (Node). The Master and the Node may be physical machines or virtual machines in a cloud environment. The cloud environment is a computing cluster that includes at least one cloud computing device (such as a central server). In some implementations, the Master and the Node may also be physical machines or virtual machines in an edge environment. The edge environment is a computing cluster that includes at least one edge computing device (such as an edge server). In some other implementations, the Master and the Node may also be end devices or virtual machines on the end devices. It should be noted that the Master and the Node may be physical machines or virtual machines in the same environment or in different environments, for example, the Master may be a physical machine in the cloud environment and the Node may be a physical machine in the edge environment.

There are a group of processes related to cluster management running on the Master, such as an interface server (kube-apiserver), a kube controller manager (kube-controller-manager), a scheduler (kube-scheduler), a memory (etcd), and the kube-apiserver relies on the etcd to store data. Through these processes, the Master can realize management capabilities such as resource management, pod scheduling, flexible scaling, security control, system monitoring and error correction to the whole cluster.

A process of an application program runs on the Node to provide the resource needed for the running of the application program. The process of the application program runs in the container of the pod. There are also service processes running on the Node, such as an agent (kubelet), a network agent (kube-proxy), through which the Node can realize creating, starting, monitoring, restarting, destroying and loading balance of the pod.

A Kubernetes cluster including a Master and a Node is taken as an example to illustrate in FIG. 1. In some implementations, the Kubernetes cluster may include multiple nodes, so that the application can be deployed in multiple nodes. Furthermore, the Kubernetes cluster may also include multiple Masters, and when one Master fails, another Master can be enabled, thus ensuring high availability.

In the following, the technical solutions in the embodiments of the present disclosure will be clearly and completely described in combination with the drawings of the embodiments of the present disclosure, and obviously, the described embodiments are only a part of the embodiments of the present disclosure, but not the whole embodiments. Based on the embodiments of the present disclosure, all other embodiments obtained by those skilled in the art without paying creative efforts belong to the scope of protection of the present disclosure.

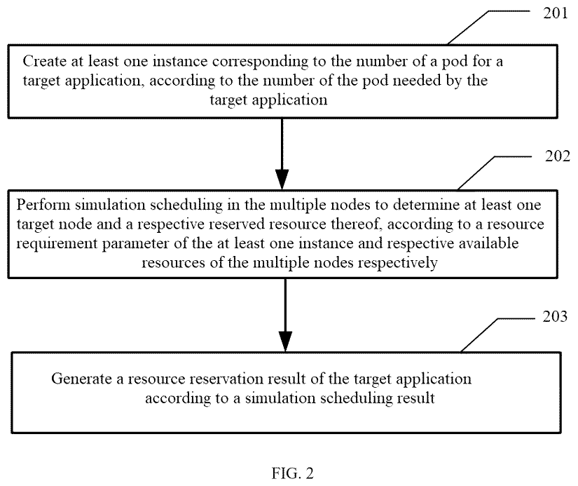

FIG. 2 is a flowchart of an embodiment of a resource processing method according to an embodiment of the present disclosure, and the method may include the following steps.

201, create at least one instance corresponding to the number of a pod for a target application, according to the number of the pod needed by the target application.

According to the embodiment of the present disclosure, the target application may include a containerized application, and the containerized application includes an application that can be packaged into a virtual container to run and publish.

The resource processing method provided in the embodiment of the present disclosure may be performed in response to a resource processing request, and the resource processing request may carry the number of the pod needed by the target application and a resource requirement parameter needed by each pod.

According to the embodiment of the present disclosure, the resource processing request may be used to request the Kubernetes system to perform resource reservation for the target application, and resource reservation may refer to reserving the resource that meets the running of the target application for the target application from the node of the Kubernetes system before performing resource scheduling for the target application formally.

According to the embodiment of the present disclosure, the resource may include a computing resource and a storage resource, such as a central processing unit (CPU) resource, a graphics processing unit (GPU) resource, a memory resource, a cache resource.

According to the embodiment of the present disclosure, in response to the resource processing request, an instance set corresponding to the target application may be created first, and then instances corresponding to the number of the pod needed by the target application may be created in the instance set.

According to the embodiment of the present disclosure, the number of the instance may be the same as the number of the pod needed by the target application.

According to the embodiment of the present disclosure, step 201 may be performed by using a control engine, and the control engine may be deployed on the master node of the Kubernetes system for monitoring and managing the instance set in the Kubernetes system.

202, perform simulation scheduling in the multiple nodes to determine at least one target node and a respective reserved resource thereof, according to a resource requirement parameter of the at least one instance and respective available resources of the multiple nodes respectively.

According to the embodiment of the present disclosure, the multiple nodes may all be working nodes of the Kubernetes system.

According to the embodiment of the present disclosure, the resource requirement parameter of the instance may be determined according to a resource requirement parameter needed by the pod carried in the resource processing request.

According to the embodiment of the present disclosure, the simulation scheduling may refer to performing simulation of the resource scheduling process of the target application in the Kubernetes system by using the instance to replace the pod before performing resource scheduling for the target application formally, so as to reserve the resource for the target application.

According to the embodiment of the present disclosure, the number of the target node may be the same as the number of the instance, that is, a respective target node may be determined for each instance respectively. But not limited to this, the number of the target node may be less than the number of the instance, that is, there may be at least two instances for which a same target node is determined.

According to the embodiment of the present disclosure, the process of determining a target node for an instance is the process of determining a node for the instance that meets its resource requirement parameter.

According to the embodiment of the present disclosure, the reserved resource of the target node may represent that the target node performs resource reservation for its corresponding instance, that is, the resource amount contained in the reserved resource of the target node can only be used by the pod corresponding to the instance when performing resource scheduling for the target application, but other application programs cannot use it.

According to the embodiment of the present disclosure, when there are multiple instances, the target node may be determined for each instance in parallel, so that the process of simulation scheduling can be accelerated.

According to the embodiment of the present disclosure, the process of the simulation scheduling may be targeted at each node in the Kubernetes system, that is, when determining the target node for the instance, each node in the Kubernetes system can be determined as a potential target node, so that the instance of the target application can enjoy the resource of the entire Kubernetes system, and the success rate of resource scheduling for the target application can be further improved.

According to the embodiment of the present disclosure, step 202 may be performed by using a scheduling engine, the scheduling engine may be deployed on the master node of the Kubernetes system, and is used to realize the process of the simulation scheduling for the instance and determine the target node for the instance.

203, generate a resource reservation result of the target application according to a simulation scheduling result, where the resource reservation result is used to instruct to perform resource scheduling for the target application by using the reserved resource of the at least one target node.

According to the embodiment of the present disclosure, in a case of that the target node is determined for each instance, the target node and the reserved resource, corresponding to each instance, may be statistic summarized to generate the resource reservation result.

According to the embodiment of the present disclosure, the resource reservation result may be stored in a form of a resource reservation account book, and the resource reservation account book records identification information of each target node and the reserved resource of each target node.

In the embodiment of the present disclosure, before performing resource scheduling for the application program, according to the number of the pod needed by the target application, at least one instance corresponding to the number of the pods is first created for the target application; according to the resource requirement parameter of the at least one instance and respective available resources of multiple nodes respectively, simulation scheduling in the multiple nodes is performed to determine at least one target node and the respective reserved resource thereof; according to the simulation scheduling result, the resource reservation result of the target application is generated to reserve the resource for the target application, so when performing resource scheduling for the application program, the reserved resource can be directly used for performing the resource scheduling, and the technical effect of improving the success rate of resource scheduling is achieved.

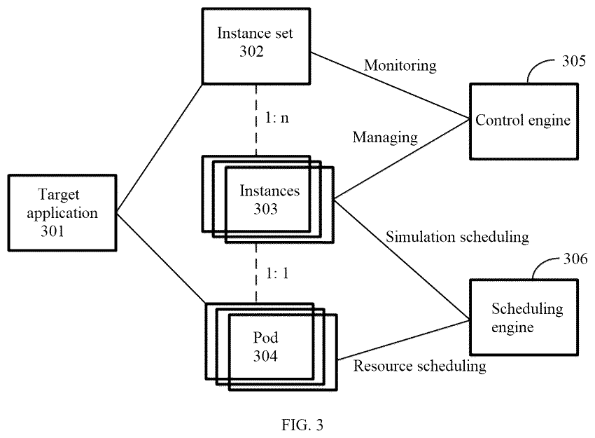

FIG. 3 schematically shows a schematic diagram of a resource processing method according to an embodiment of the present disclosure.

As shown in FIG. 3, 301 denotes a target application to be created, for the target application 301, an instance set 302 may be created, and the instance set 302 may include instances 303 corresponding to the number of pods 304 needed by the target application 301, that is, the instance set 302 and the instances 303 have a one-to-many relationship, while the instances 303 has a one-to-one relationship with the pods 304 needed by the target application 301. The instance set 302 and the instances 303 are subject to monitoring and managing of the control engine 305, and the instances 303 is subject to simulation scheduling of the scheduling engine 306.

According to the embodiment of the present disclosure, the resource processing method further includes:
in a case of that the simulation scheduling fails, generating prompt information according to the resource requirement parameter of the at least one instance, where the prompt information is used to prompt to perform resource expansion of the multiple nodes according to the resource requirement parameter; and
outputting the prompt information.

According to the embodiment of the present disclosure, the failure of the simulation scheduling may be confirmed in the case that there exists at least one instance for which a target node cannot be determined.

According to the embodiment of the present disclosure, in multiple instances, when there exists at least one instance for which a target node cannot be determined, it indicates that the current Kubernetes system has no remaining resources for the running of the target application, which will lead to the failure of creating the target application. In this case, the process of simulation scheduling may be suspended, and the resource requirement parameter of the at least one instance for which the target node cannot be determined is obtained, and prompt information may be generated according to the resource requirement parameter.

According to the embodiment of the present disclosure, resource expansion may be performed for the Kubernetes system by way of releasing resources for the Kubernetes system or adding resources for the Kubernetes system. For example, it can be inquired whether there is an application running in at least one node in the Kubernetes system in an idle state, and if there is, the resources that the node provides to the idle application may be released. Or resources may be added for one or more nodes.

According to the embodiment of the present disclosure, after performing resource expansion for the Kubernetes system, the simulation scheduling operation may be continued to perform until the target node is determined for each instance.

According to the embodiment of the present disclosure, in a scenario of, for example, new application creating, it is usually necessary to determine a target node for an instance corresponding to each pod of the new application, while in a scenario such as expansion or node migration for a created application, it is only necessary to determine a target node for instances corresponding to some pods of the application. In this case, an instance for which resource reservation needs to be performed may be determined from multiple candidate instances corresponding to the pods of the application, and then a target node may be determined only for the instance for which resource reservation needs to be performed, so that the flexibility of resource reservation can be improved.

According to the embodiment of the present disclosure, the resource processing method may further include:
obtaining a request for requesting to perform resource scheduling for the target application;
obtaining, in response to the request, the resource reservation result; and
performing resource scheduling for the target application by using a reserved resource of the at least one target node indicated by the resource reservation result.

According to the embodiment of the present disclosure, after reserving the resource for the target application through simulation scheduling, the request for requesting to perform resource scheduling for the target application may be obtained. The request may include identification information of the target application.

According to the embodiment of the present disclosure, after obtaining the request, the resource reservation result may be obtained, and the resource reservation result is inquired to determine whether the reserved resource for the target application is recorded in the resource reservation result.

According to the embodiment of the present disclosure, the resource processing request may also carry the identification information of the target application, and after performing the simulation scheduling for the target application, marking processing may be performed for each target node by using the identification information of the target application. Therefore, after obtaining the resource processing request, it can be inquired whether there is a target node carrying the identification information of the target application in the resource reservation result, and if so, the reserved resource of the target node may be used to perform resource scheduling for the target application.

According to the embodiment of the present disclosure, if there is no target node with the identification information of the target application in the resource reservation result, a default resource scheduling method of Kubernetes system may be used to perform resource scheduling for the target application.

According to the embodiment of the present disclosure, the resource requirement parameter includes a resource demand.

According to the embodiment of the present disclosure, performing, according to the resource requirement parameter of the at least one instance and the respective available resources of multiple nodes respectively, simulation scheduling in multiple nodes to determine the at least one target node and the respective reserved resource thereof may be specifically realized as follows:
obtaining available resource amounts of the multiple nodes respectively;
comparing the available resource amounts of the multiple nodes with the resource demand of the at least one instance to determine, for any instance, a target node with an available resource amount greater than or equal to a resource demand; and
determining the resource demand as the resource reservation of the target node.

According to the embodiment of the present disclosure, when performing simulation scheduling, the available resource amount of each node in the Kubernetes system may be determined ergodically, and then the resource demand of the instance is compared with the available resource amount of each node.

According to the embodiment of the present disclosure, a first node whose available resource amount is not less than the resource demand that is determined in the process of comparing the resource demand of the instance with the available resource amount of the node, may be taken as the target node corresponding to the instance.

According to the embodiment of the present disclosure, after determining the target node for the instance, the resource amount in the available resource amount of the target node, which is equal to the resource demand, may be frozen to prevent this part of resource from being occupied by other applications. After freezing the resource amount in the available resource amount of the target node that is equal to the resource demand, when the Kubernetes system performs resource scheduling for other applications different from the target application, the available resource amount displayed by the target node for the Kubernetes system is the actual available resource amount minus the resource demand of the instance.

According to the embodiment of the present disclosure, when determining the target node for the instance, other parameters such as affinity may be considered in addition to the resource demand. Affinity may include hard affinity and soft affinity. Hard affinity may refer to that an instance with hard affinity, a resource requirement parameter, should determine the node with the specified attribute as the target node. Soft affinity may refer to that an instance with soft affinity, a resource requirement parameter, should determine the node with the specified attribute as the target node. If the node with the specified attribute does not meet other resource requirement parameters of the instance, other nodes may also be determined as the target node.

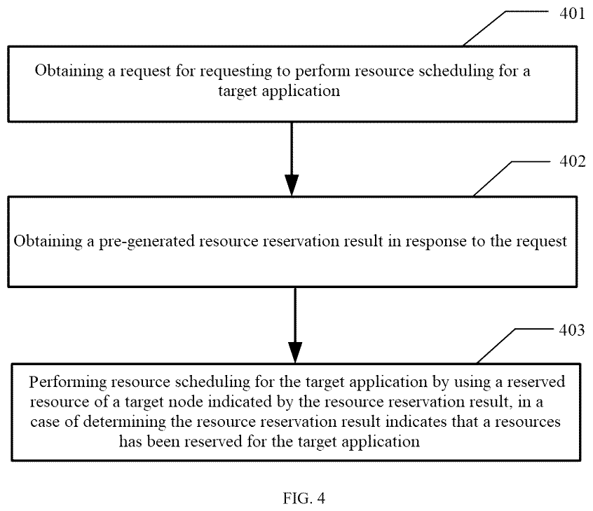

FIG. 4 is a flowchart of an embodiment of a resource scheduling method according to an embodiment of the present disclosure, and the method may include the following steps:
401, obtaining a request for requesting to perform resource scheduling for a target application;
402, obtaining a pre-generated resource reservation result in response to the request; and
403, performing resource scheduling for the target application by using a reserved resource of a target node indicated by the resource reservation result, in a case of determining the resource reservation result indicates that a resource has been reserved for the target application.

According to the embodiment of the present disclosure, the resource reservation result may be generated by using the resource processing method provided in the embodiment of the present disclosure, its specific implementation is the same as or similar to that described above, which is not repeated here.

According to an embodiment of the present disclosure, performing the resource scheduling for the target application by using the reserved resource of the target node indicated by the resource reservation result may be specifically realized as follows:
creating at least one pod for the target application; and
deploying the at least one pod to the at least one target node.

According to the embodiment of the present disclosure, for each instance, a target node that can meet the resource requirement parameter of the instance has been determined when performing simulation scheduling to the instance, the number of the instance and the number of the pod are corresponding, and the resource requirement parameter of the instance is consistent with that of the pod, so that the pod can be directly deployed to the target node corresponding to the instance when performing resource scheduling for the target application, and the pod can make use of the reserved resource on the target node, which ensures the success rate of the resource scheduling.

In a specific example, the target application may need three pods, which are pod A1, pod A2 and pod A3 respectively, so that an instance set may be created, which includes instance B1, instance B2 and instance B3, and the resource requirement parameters of instance B1, instance B2 and instance B3 are consistent with those of pod A1, pod A2 and pod A3, respectively.

It should be noted that during the simulation scheduling stage, the pod may not be actually created, but an instance set may be created according to the number of the pod and the resource requirement parameter.

After the instance set is created, the simulation scheduling may be performed, that is, at least three target nodes meeting the resource requirement parameters of instance B1, instance B2 and instance B3 are determined in the Kubernetes system. For example, instance B1 corresponds to target node C1, instance B2 corresponds to target node C2, and instance B3 corresponds to target node C3, and the corresponding relationship is recorded in the resource reservation account book.

When performing resource scheduling for the target application, pod A1, pod A2 and pod A3 may be created first, and then by inquiring the resource reservation account book, it can be determined that target node C1, target node C2 and target node C3 have reserved resources for pod A1, pod A2 and pod A3 respectively, so that pod A1, pod A2 and pod A3 can be directly deployed to target node C1, target node C2 and target node C3 respectively. Moreover, since it has been already determined during the simulation scheduling that the target nodes meet the resource requirement parameters of the instances, it can be ensured that the target nodes also meet the resource requirement parameters of the pods during the resource scheduling, thus ensuring the success rate of the resource scheduling.

According to an embodiment of the present disclosure, respectively deploying the at least one pod to the at least one target node respectively corresponding to the at least one instance may be specifically realized as follows:
performing resource scheduling in the at least one target node to deploy the at least one pod to the at least one target node; or, deploying the at least one pod to the at least one target node according to a respective resource reservation of the at least one target node and a respective resource demand of the at least one pod.

According to the embodiment of the present disclosure, when creating the instance, the corresponding relationship between the instance and the pod can be determined, so that the pod can be deployed to the corresponding target node according to the corresponding relationship. In the above specific embodiments, for example, when creating the instance set, it can be determined that instance B1 is used to simulate pod A1, instance B2 is used to simulate pod A2, and instance B3 is used to simulate pod A3.

According to the embodiment of the present disclosure, for example, it is also possible that when creating the instance, the corresponding relationship between the instance and the pod is not specified, and after the simulation scheduling is completed and the pod is actually created, the pod is deployed according to the resource demand of the pod and the resource reservation of the target node, for example, the pod can be deployed to the target node for which the resource reservation is equal to the resource demand.

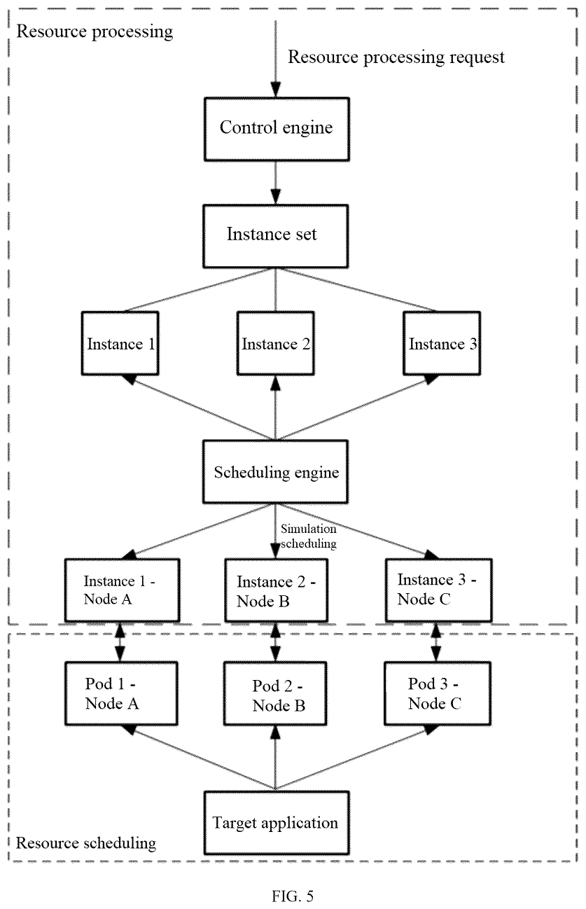

FIG. 5 schematically shows a schematic diagram of a resource scheduling method according to an embodiment of the present disclosure.

As shown in FIG. 5, before performing resource scheduling, resource processing may be performed. Specifically, the control engine can create an instance set in response to a resource processing request. In this example, the instance set may include three instances.

After the instance set is created, the scheduling engine may be used to perform simulation scheduling for the three instances in the instance set, and the target nodes may be respectively determined for each instance from the Kubernetes system.

After the simulation scheduling is completed, three pods may be created for the target application. According to the corresponding relationship between the pods and the instances, the pods are respectively deployed to the target nodes that have reserved resources in advance, to realize resource scheduling.

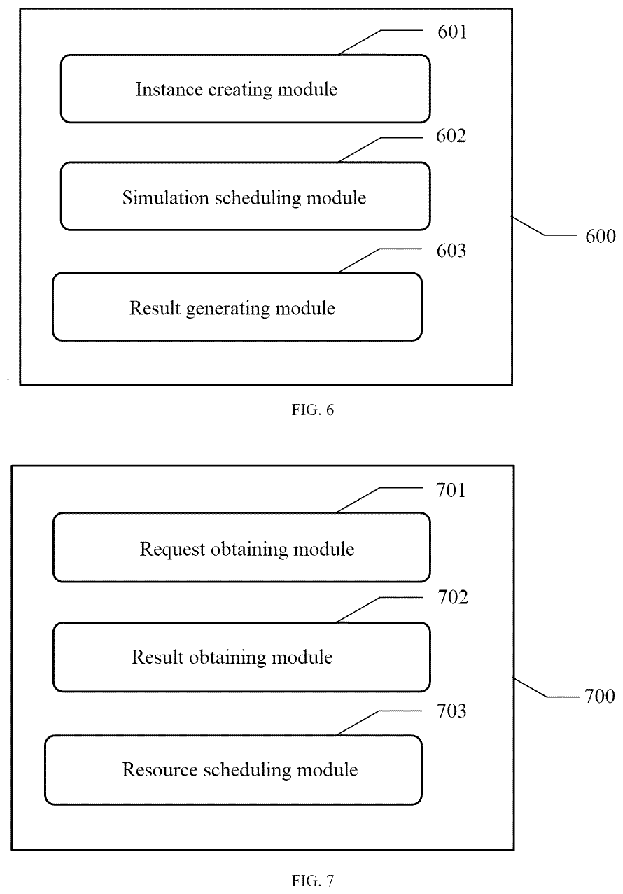

FIG. 6 is a schematic structural diagram of an embodiment of a resource processing apparatus according to an embodiment of the present disclosure, and the resource processing apparatus 600 includes:
an instance creating module 601, configured to create, according to the number of a pod needed by a target application, at least one instance corresponding to the number of the pod for the target application;
a simulation scheduling module 602, configured to perform, according to a resource requirement parameter of the at least one instance and respective available resources of multiple nodes respectively, simulation scheduling in the multiple nodes to determine at least one target node and a respective reserved resource thereof; and
a result generating module 603, configured to generate, according to a simulation scheduling result, a resource reservation result of the target application, where the resource reservation result is used to instruct to perform resource scheduling for the target application by using the reserved resource of the at least one target node.

According to the embodiment of the present disclosure, a control engine may be configured in the instance creating module 601 to monitor and manage the instance set in the Kubernetes system.

According to the embodiment of the present disclosure, a scheduling engine may be configured in the simulation scheduling module 602 to realize the process of performing simulation scheduling for the instance, to determine a target node for the instance.

According to the embodiment of the present disclosure, the resource processing apparatus 600 may further include:
a request obtaining module, configured to obtain a request for requesting to perform resource scheduling for the target application;
a result obtaining module, configured to obtain the resource reservation result in response to the request; and
a resource scheduling module, configured to perform resource scheduling for the target application by using a reserved resource of the at least one target node indicated by the resource reservation result.

According to the embodiment of the present disclosure, the resource processing apparatus 600 may further include:

a prompt information generating module, configured to generate prompt information according to the resource requirement parameter of the at least one instance, in a case that the simulation scheduling fails, where the prompt information is used to prompt to perform resource expansion of the multiple nodes according to the resource requirement parameter; and
a prompt information outputting module, configured to output the prompt information.

According to the embodiment of the present disclosure, the resource requirement parameter includes a resource demand.

According to the embodiment of the present disclosure, the simulation scheduling module 602 includes:
a resource amount obtaining unit, configured to obtain available resource amounts of the multiple nodes respectively;
a comparing unit, configured to compare the available resource amounts of the multiple nodes with the resource demand of the at least one instance to determine, for any instance, a target node with an available resource greater than or equal to a resource demand of the instance; and
a determining unit, configured to determine the resource demand as a resource reservation of the target node.

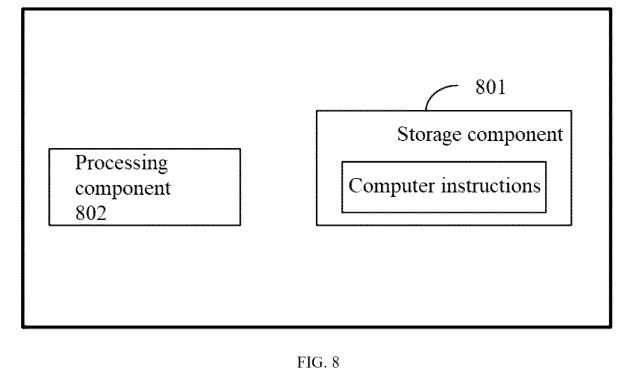

FIG. 7 is a schematic structural diagram of an embodiment of a resource scheduling apparatus according to an embodiment of the present disclosure, and the resource scheduling apparatus 700 may include:
a request obtaining module 701, configured to obtain a request for requesting to perform resource scheduling for a target application;
a result obtaining module 702, configured to, in response to the request, obtain a pre-generated resource reservation result, where the resource reservation result is generated according to a simulation scheduling result, and the simulation scheduling result includes at least one target node and a reserved resource determined by performing simulation scheduling in multiple nodes according to a resource requirement parameter of at least one instance of the target application and respective available resources of the multiple nodes;
a resource scheduling module 703, configured to perform resource scheduling for the target application by using the reserved resource of the at least one target node indicated by the resource reservation result, in a case of determining the resource reservation result indicates that a resource has been reserved for the target application.

According to the embodiment of the present disclosure, the resource scheduling module 703 may include:
a pod creating unit, configured to create at least one pod for the target application; and
a deploying unit, configured to deploy the at least one pod to the at least one target node.

According to the embodiment of the present disclosure, the deploying unit includes:
a first deploying subunit, configured to perform resource scheduling in the at least one target node to deploy the at least one pod to the at least one target node; or
a second deploying subunit, configured to deploy the at least one pod to the at least one target node according to a respective resource reservation of the at least one target node and a respective resource demand of the at least one pod.

The resource processing apparatus described in FIG. 6 and the resource scheduling apparatus described in FIG. 7 may respectively perform the resource processing method described in the embodiment shown in FIG. 2 and the resource scheduling method described in the embodiment shown in FIG. 4, and their implementation principles and technical effects will not be described in detail. For the resource processing apparatus in FIG. 6 and the resource scheduling apparatus in FIG. 7 in the above embodiments, the specific ways in which each module and unit performs operations have been described in detail in the embodiments of related methods, and will not be described in detail here.

In one possible design, the resource processing apparatus described in FIG. 6 and the resource scheduling apparatus described in FIG. 7 may be implemented as a computing device. As shown in FIG. 8, the computing device may include a storage component 801 and a processing component 802.

The storage component 801 stores one or more computer instructions; where the one or more computer instructions are used for being called and executed by the processing component 802 to implement the resource processing method described in the embodiment shown in FIG. 2 and the resource scheduling method described in the embodiment shown in FIG. 4.

Of course, the computing device may further include other components, such as an input/output interface, a communication component. The input/output interface provides an interface between the processing component and a peripheral interface module, the above peripheral interface module may be an output device, an input device, etc. The communication component is configured to facilitate wired or wireless communication between the computing device and other devices, etc.

The computing device may be a physical device or an elastic computing host provided by a cloud computing platform, in which case the computing device may refer to a cloud server, and the above processing component and storage component may be basic server resources rented or purchased from the cloud computing platform.

When the computing device is a physical device, it can be implemented as a distributed cluster composed by multiple servers or terminal devices, or as a single server or a single terminal device.

In practical application, the computing device can specifically deploy a node in a message queue system, which is implemented as a producer, a consumer, a transit server or a naming server in the message queue system.

An embodiment of the present application further provides a computer-readable storage medium storing a computer program, and when the computing program is executed by a computer, the resource processing method described in the embodiment shown in FIG. 2 and the resource scheduling method described in the embodiment shown in FIG. 4 can be implemented.

An embodiment of the present application further provides a computer program product including a computer program, and when the computing program is executed by a computer, the resource processing method described in the embodiment shown in FIG. 2 and the resource scheduling method described in the embodiment shown in FIG. 4 can be implemented.

The processing component in the above corresponding embodiment may include one or more processors to execute computer instructions, to complete all or part of the steps in the above methods. Of course, the processing component may also be implemented by one or more application-specific integrated circuits (ASIC), a digital signal processor (DSP), a digital signal processing device (DSPD), a programmable logic device (PLD), a field programmable gate array (FPGA), a controller, a microcontroller, a microprocessor or other electronic components, for performing the above methods.

The storage component is configured to store various types of data to support operations in the device. The storage component may be implemented by any type of volatile or nonvolatile storage device or their combination, such as a static random access memory (SRAM), an electrically erasable programmable read-only memory (EEPROM), a erasable programmable read-only memory (EPROM), a programmable read-only memory (PROM), a read-only memory (ROM), a magnetic memory, a flash memory, a magnetic disk or an optical disk.

It can be clearly understood by those skilled in the art that for the convenience and conciseness of description, the specific working processes of the systems, apparatuses and units described above may refer to the corresponding processes in the embodiments of the above methods, and will not be repeated here.

The apparatus embodiments described above are only schematic, in which the units described as separate components may or may not be physically separated, and the components displayed as units may or may not be physical units, that is, they may be located in one place or distributed to multiple network units. Some or all of the modules may be selected according to actual needs to achieve the purpose of the solution of this embodiment. And it is can be understood and implemented by those skilled in the art without paying creative efforts.

Through the description of the above embodiments, those skilled in the art can clearly understand that each embodiment may be implemented by means of software and necessary general hardware platform, and of course it may also be implemented by hardware. Based on this understanding, the essence of the above technical solutions or the part that has contributed to the prior art can be embodied in the form of a software product, which may be stored in a computer-readable storage medium, such as a ROM/RAM, a magnetic disk, an optical disk, and include several instructions for causing a computer device (which may be a personal computer, a server, or a network device, etc.) to perform the methods described in various embodiments or some parts of the embodiments.

Finally, it should be explained that the above embodiments are only used to illustrate the technical solutions of the present application, but not to limit it. Although the present application has been described in detail with reference to the foregoing embodiments, it should be understood by those skilled in the art that they can still modify the technical solutions described in the foregoing embodiments or substitute some technical features with equivalents. However, these modifications or substitutions do not make the essence of the corresponding technical solutions deviate from the spirit and scope of the technical solutions of various embodiments of the present application.

1. A resource processing method, comprising:
creating, according to a number of a pod needed by a target application, at least one instance corresponding to the number of the pod for the target application;
performing, according to a resource requirement parameter of the at least one instance and respective available resources of multiple nodes respectively, simulation scheduling in the multiple nodes to determine at least one target node and a respective reserved resource thereof; and
generating, according to a simulation scheduling result, a resource reservation result of the target application, wherein the resource reservation result is used to instruct to perform resource scheduling for the target application by using the reserved resource of the at least one target node.

2. The method according to claim 1, wherein the method further comprises:
obtaining a request for requesting to perform resource scheduling for the target application;
obtaining, in response to the request, the resource reservation result of the target application; and
performing resource scheduling for the target application by using a reserved resource of the at least one target node indicated by the resource reservation result.

3. The method according to claim 1, further comprising:
in a case that the simulation scheduling fails, generating prompt information according to the resource requirement parameter of the at least one instance, wherein the prompt information is used to prompt to perform resource expansion of the multiple nodes according to the resource requirement parameter; and
outputting the prompt information.

4. The method according to claim 1, wherein the resource requirement parameter comprises a resource demand;
wherein performing, according to the resource requirement parameter of the at least one instance and the respective available resources of the multiple nodes respectively, the simulation scheduling in the multiple nodes to determine the at least one target node and the respective reserved resource thereof comprises:
obtaining available resource amounts of the multiple nodes respectively;
comparing the available resource amounts of the multiple nodes with the resource demand of the at least one instance to determine, for any instance, a target node with an available resource amount greater than or equal to a resource demand of the instance; and
determining the resource demand as a resource reservation of the target node.

5. A resource scheduling method, comprising:
obtaining a request for requesting to perform resource scheduling for a target application;
obtaining, in response to the request, a pre-generated resource reservation result; wherein the resource reservation result is generated according to a simulation scheduling result, and the simulation scheduling result comprises at least one target node and a reserved resource determined by performing simulation scheduling in multiple nodes according to a resource requirement parameter of at least one instance of the target application and respective available resources of the multiple nodes; and
performing resource scheduling for the target application by using the reserved resource of the at least one target node indicated by the resource reservation result, in a case of determining the resource reservation result indicates that a resource has been reserved for the target application.

6. The method according to claim 5, wherein performing the resource scheduling for the target application by using the reserved resource of the at least one target node indicated by the resource reservation result comprises:
creating at least one pod for the target application; and
deploying the at least one pod to the at least one target node.

7. The method according to claim 6, wherein deploying the at least one pod to the at least one target node comprises:
performing resource scheduling in the at least one target node to deploy the at least one pod to the at least one target node; or, deploying the at least one pod to the at least one target node according to a respective resource reservation of the at least one target node and a respective resource demand of the at least one pod.

8. A computing device, comprising: a processing component and a storage component;
wherein the storage component stores one or more computer instructions; and the one or more computer instructions are used for being called and executed by the processing component; and
the processing component is configured to:
create, according to a number of a pod needed by a target application, at least one instance corresponding to the number of the pod for the target application;
perform, according to a resource requirement parameter of the at least one instance and respective available resources of multiple nodes respectively, simulation scheduling in the multiple nodes to determine at least one target node and a respective reserved resource thereof; and
generate, according to a simulation scheduling result, a resource reservation result of the target application, wherein the resource reservation result is used to instruct to perform resource scheduling for the target application by using the reserved resource of the at least one target node.

9. A computing device, comprising: a processing component and a storage component;
wherein the storage component stores one or more computer instructions; and the one or more computer instructions are used for being called and executed by the processing component; and when the one or more computer instructions are executed by the processing component, the resource scheduling method according to claim 5 is implemented.

10. A non-transitory computer storage medium, storing a computer program, wherein when the computer program is executed by a computer, the resource processing method according claim 1 is implemented.

11. The method according to claim 2, wherein the request for requesting to perform resource scheduling for the target application comprises identification information of the target application.

12. The method according to claim 3, wherein the failure of the simulation scheduling is confirmed in a case that there exists at least one instance for which a target node cannot be determined.

13. The computing device according to claim 8, wherein the processing component is further configured to:
obtain a request for requesting to perform resource scheduling for the target application;
obtain, in response to the request, the resource reservation result of the target application; and
perform resource scheduling for the target application by using a reserved resource of the at least one target node indicated by the resource reservation result.

14. The computing device according to claim 13, wherein the request for requesting to perform resource scheduling for the target application comprises identification information of the target application.

15. The computing device according to claim 8, wherein the processing component is further configured to:
in a case that the simulation scheduling fails, generate prompt information according to the resource requirement parameter of the at least one instance, wherein the prompt information is used to prompt to perform resource expansion of the multiple nodes according to the resource requirement parameter; and
output the prompt information.

16. The computing device according to claim 15, wherein the failure of the simulation scheduling is confirmed in a case that there exists at least one instance for which a target node cannot be determined.

17. The computing device according to claim 8, wherein the resource requirement parameter comprises a resource demand, and the processing component is configured to:
obtain available resource amounts of the multiple nodes respectively;
compare the available resource amounts of the multiple nodes with the resource demand of the at least one instance to determine, for any instance, a target node with an available resource amount greater than or equal to a resource demand of the instance; and
determine the resource demand as a resource reservation of the target node.

18. The computing device according to claim 9, wherein the processing component is configured to:
create at least one pod for the target application; and
deploy the at least one pod to the at least one target node.

19. The computing device according to claim 18, wherein the processing component is configured to:
perform resource scheduling in the at least one target node to deploy the at least one pod to the at least one target node; or, deploy the at least one pod to the at least one target node according to a respective resource reservation of the at least one target node and a respective resource demand of the at least one pod.

20. A non-transitory computer storage medium, storing a computer program, wherein when the computer program is executed by a computer, the resource scheduling method according to claim 5 is implemented.
